(19) United States
(12) Patent Application Publication
(10) Pub. No.: US 2007/0187415 A1
(43) Pub. Date: Aug. 16, 2007

(54) Glass fiber reinforced gas cylinder

(76) Inventors: Sean D'Silva, Englewood, CO (US); Thomas F. Stehlin, Kriftel (DE)

Correspondence Address: JOHNS MANVILLE, 10100 WEST UTE AVENUE, LITTLETON, CO, 80127, US

(21) Appl. No.: 11/354,203

(22) Filed: Feb. 14, 2006

(51) Int. Cl. F17C 1/02

(52) U.S. Cl. 220/586

(57) ABSTRACT

Provided is a glass fiber reinforced cylinder, suitable for use as a high pressure gas cylinder. The reinforced cylinder is prepared by centrifugally creating an inner layer of glass fiber reinforced resin in the cylinder.

### BACKGROUND OF THE INVENTION

1. Field of the Invention

The invention relates to a glass fiber reinforced cylinder-type gas container, its production and use. More particularly, the container is a glass fibers reinforced metal-plastic composite that is made by a novel centrifugal casting method. The new gas cylinder offers advantages over other metal-based products as well as over glass fiber reinforced gas cylinders that are made according to standard production methods.

2. Description of the Related Art

The manufacturing of pressurized gas cylinders involves a very ambitious and complicated technology. Mainly safety and cost issues play a prominent role in this interesting market segment. Up to now metal constructions are dominating the market due to their advantages regarding technology and safety.

Pressure vessels have been produced in a wide variety of designs. For example, early designs were fabricated from high tensile strength alloy steels, which resulted in a substantial weight per unit of volume of vessel, and were subject to hydrogen embrittlement. Of course, these types of vessels tended to be unwieldy and, therefore, had a limited application for portable use.

The production technology of metal cylinders is mature. This includes the use of aluminum, which opened new application segments for such containers.

With the advent of impact extruded aluminum, pressure vessels were improved to the extent that an approximate thirty percent weight reduction was achieved over the conventional steel pressure vessels, while providing an extremely high resistance to industrial and marine environments as well as to many corrosive gases, albeit with relatively limited size and capacity. After the aluminum pressure vessel became well-established, further improvements involved the over-winding of the circumference of an inner liner with a composite material, such as a high strength filament material in an epoxy resin or the like.

The overwound liner design exhibited an increased capacity by a significant amount, with a relatively small increase in weight. However, one problem that has prevented widespread use of the overwound vessels in general use applications is their lack of high cyclic fatigue performance, which is often below 30,000 to 40,000 cycles, well below the 100,000 cycles required for general use cylinders by the United States Department of Transportation. The deficiency is due largely to the fact that these vessels are often designed with their longitudinal burst strength being different from their radial, or hoop, burst strength, both before and after the vessel is overwound with the composite material. This variance between the longitudinal and radial burst strengths causes stress imbalances throughout the vessels and, when very high cycles of pressurization and depressurization occur during use, these stress imbalances cause premature failure, particularly in the “knuckle” radius of the base and head, which is required for producing a vessel by impact extrusion.

Also, these types of vessels were often designed with the thickness ratio between the walls of the vessels and the composite being relatively low. As a result, the vessel would be completely overwound with the composite material, and the head configuration of the vessel often was toroispherical or ellipsoidal in order to keep the filament material in place on the heads during the winding operation. However, this further compounded the stress distribution since, in these designs, the stress at the juncture between the side wall and the head is at least two to three times greater than that in a hemispherical head configuration.

Some pressure vessels according to the prior art also have a relatively short length compared to the inside diameter of the vessel. This leads to a problem known as the “end effect” in which resistance to cyclic fatigue is relatively low due to the fact that the head and base stiffness is transferred to the side wall of the vessel.

The prior art pressure vessels which employ high strength filament material in a matrix usually employ the filament material in a matrix of an epoxy resin or an ordinary polyester resin having limited elongation. These resins have a typical elongation of 2% to 3%, whereas the elongation of the cylinder material is considerably greater, for example, usually 10%-25% for aluminum, depending on the type of aluminum and its thickness. Furthermore, where these resins comprise a matrix for high strength filament material, an even lower elongation is exhibited for the composite material of resin and filaments. The publication “Aluminum Standards and Data 1979”, published by The Aluminum Association, Incorporated, defines “elongation” as “the percentage increase in distance between two gauge marks that results from stressing the specimen in tension to fracture”. This difference is important where the pressure vessel is initially pressurized, as in an autofrettage process, to obtain a pre-tension in the walls of the pressure vessel. In the autofrettage process, the diameter and length of the vessel are increased as a result of internally applied pressure. A substantial expansion of the vessel also occurs in normal use when it is filled with gas under pressure. By “substantial expansion” is meant expansion of more than 3%. Although the elongation characteristics of the material of the vessel are sufficient to accommodate such substantial expansion, the elongation characteristics of the currently used resins, which are chosen primarily for their corrosion resistance properties, are not sufficient. Thus, the resin matrix containing the high strength filaments wound around the pressure vessel fractures or cracks because of the difference between the expansion of the cylinder and the elongation of the resin matrix. The cracking allows moisture and dirt to migrate into the matrix and engage the wall of the vessel, where they remain and cause corrosion.

It can be seen that a similar problem exists for pipes which are reinforced with high strength filaments in a resin matrix and then autofrettaged or bent along their lengths to fit various applications. For example, when pipe is assembled in a pipeline, the pipe must conform to the supporting earth and where the pipe goes over hills or through depressions, the pipe must bend to conform. The portion of the pipe wall on the outside of the bend often undergoes substantial expansion. The previously used resins would fail where the pipe is bent.

Furthermore, currently used resins are opaque, so that any defects or corrosion which would have been visible in an unwrapped vessel are not visible. Moreover, defects in the filaments and in the resin itself below the surface are not visible. Of course, such defects or corrosion would also not be visible in a similarly wrapped pipe. In addition, especially in the case of aluminum pressure vessels or pipes, exposure to excessive heat often results in critical weaknesses in the wall which are not at all visible, even where the wall is visible.

In prior art pressure vessels which were reinforced with nonmetallic filaments, filament material ordinarily used was fiberglass of the “S-2” type, which is relatively expensive and which often snarls and breaks during winding. In addition, in prior art overwound pressure vessels which include a resinous matrix, a resin which is commonly used is epoxy resin, which is expensive. Furthermore, the epoxy resins used have a high cure temperature (on the order of 350° F.-450° F.) and a long cure time (5-8 hours). Not only do these cure characteristics give rise to special handling problems and slow the manufacturing process, but where an aluminum structure is involved, they tend to weaken the aluminum because the cure temperature of the resin is in a range where the strength of the aluminum is significantly weakened and is close to the annealling temperature (450° F.-600° F.) of the aluminum. Since aluminum is normally aged at 340° F. for about 8 hours, the cure characteristics of these epoxies can also result in over-aging the aluminum, which can radically affect the mechanical properties of the metal. For example, over-aging of the metal can cause it to become brittle and thereby fail prematurely. Moreover, epoxy resins present potential health problems and, thus, require special care.

Glass fibers reinforced cylinders are currently being made using the filament winding technique. The glass fibers are wound onto a (mostly) metal form that acts as the support for the fiber layers and that defines the shape and geometry of the cylinder. The resin is brought simultaneously onto the wound fibers or added after each layer. Other resin supply techniques are also possible. The endings of the cylinder that mostly are designed to take a valve or other equipment require special attention during winding to maintain the strength of the whole system. Even when produced with the highest accuracy the cylinder surface will always be rough and non-metallic.

Glass-reinforced tubes, non-metallic, are being made using technologies like filament winding or centrifugal casting. A resin fiber mixture is injected into a hollow tube-like body that acts as the support and that defines the desired geometry. By rotating the form the tube builds up. After curing and removing the support one gets a tube with a smooth surface. This method does not allow the production of cylinder shaped containers.

The industry is in need of a method for producing reinforced gas cylinders in a more efficient and effective manner. It is therefore an object of the present invention to provide such a method.

### SUMMARY OF THE INVENTION

The novel production method of the present invention eliminates the complicated and rather slow production methods of the prior art for producing reinforced, metallic based gas cylinders. It provides cylinders with high strength, simple design, low weight and metallic surfaces. It allows production with high throughput at a reasonable cost level.

The reinforced container of the present invention is comprised of an outer metallic body and an inner layer of glass fiber reinforced resin. In particular resins of high viscosity are preferred for use in preparing the containers.

In the method of the present invention, a lightweight metal cylinder is used as the support and outer shell of the container. The metal cylinder already contains the openings and threads that are needed for its function as a pressure tank. After assembling the cylinder, the reinforcing glass fibers as well as the liquid resin are introduced into the metal container. By rotating the cylinder while curing the resin a fiber-reinforced inner wall will build up inside the container. The result is a gas cylinder that contains a fiber-reinforced layer that fully covers the inner surface of the cylinder and has great strength. The metallic outer surface serves as a protective layer and facilitates the acceptance of such fiber-reinforced products in the market as an improvement over the reinforced gas cylinders available today.

### BRIEF DESCRIPTION OF THE FIGURES OF THE DRAWING

FIG. 1a-e shows a first method of conventional metal can formation.

FIG. 2a-c shows a method of conventional metal cylinder formation.

FIG. 3a-d shows the assembling of metal cylinders and the preparation of a glass reinforced cylinder in accordance with the present invention.

### DETAILED DESCRIPTION OF THE INVENTION

The production process is comprised of three steps. In a first step the metal shell is produced. The subsequent second step builds the reinforcing inner layer. The final step involves the insertion of the valves, etc. to render the cylinder commercially ready and functional.

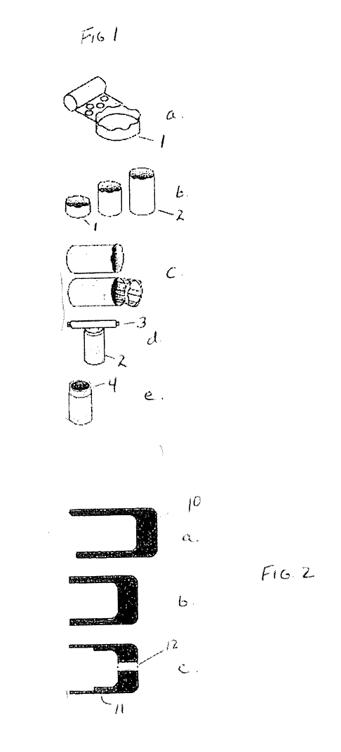

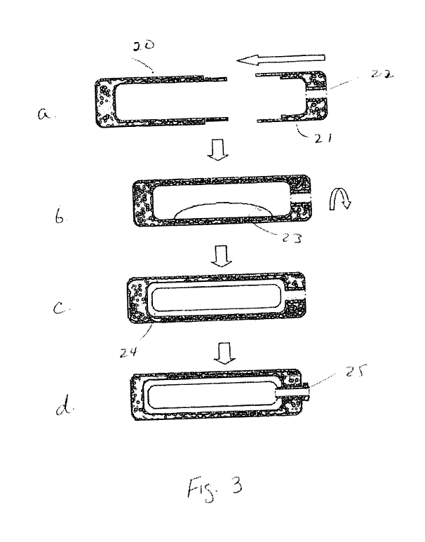

The metal container can be manufactured mainly in two different ways, shown in FIGS. 1 and 2. Both of these methods are conventional in their process steps.

The first method, shown in FIG. 1, starts with aluminum sheets and a subsequent drawing process as it is used for the production of aluminum cans. The geometry of the cylinder or can needs to be adjusted according to the requirements and ultimate end use. One important aspect is the geometry and thickness of the caps, which need to be able to take the openings and threads so a suitable valve or other closing member can be inserted. Referring to FIG. 1, the primary steps involve:

a. Cup Forming

The process starts with an aluminum coiled sheet, which is fed through a press that punches out shallow cups 1.

b. Redrawing & Ironing

The cups 1 are fed into an ironing press where successive rings redraw and iron the cup and reduce sidewall thickness to get a full-length can 2. The bottom is domed to obtain strength required to withstand internal pressure.

c. Trimming

Cans are spun as a cuffing tool trims the rough shell from the inside.

d. Bottom Varnishing

Cans 2 are conveyed past an applicator 3 that applies protective varnish to the bottom.

e. Necking and Flanging

Cans are necked-in at the top 4 to reduce can diameter and flanged to accept the end.

Referring to FIG. 2, the second method starts with a metal mold, i.e. an aluminum mold. By using pressing tools one gets a one-sided closed cylindrical body 10. The thickness of the walls can easily be adjusted in this process. For the application, particularly the bottom parts need to have a certain thicknesses to be able to take the openings and threads. More specifically, the steps involve:

a. Cylinder Forming

The process starts with an aluminum mold. A pressing ram shapes the cylinder (one side closed) out of the mold 10.

b. Re-shaping and Trimming

The cylinders are re-shaped and trimmed.

c. Necking and Flanging

Cylinders are necked-in at the top 11 to shape the correct joint diameter. A threaded hole 12 is inserted.

After production, in both cases the two parts, top and bottom, are joined together using high performance adhesives. This gives the metallic cylinder its final shape.

Once the cylinder has been prepared, the fiber and resin mixture is introduced into the cylinder through the opening. The resin needs to have a rather high viscosity to allow an efficient wetting of the fibers. Generally, the viscosity is in the range of from 20 cps to 100 cps, and more preferably from 50 cps to 100 cps. After introducing the mixture, the cylinder opening is closed and the cylinder is rotated. The cylinder is rotated at a sufficient rpm to result in the glass fiber and resin mixture covering the inside of the cylinder. In a preferred embodiment, the rotation is at a sufficient rpm to create a centrifugal force strong enough to hold the resin and glass fiber mixture to the internal walls of the cylinder, most preferably until the curing of the resin is at least begun. The rotation is continued until an even internal coating is achieved. Depending on the resin used, the cylinder needs to be heated to a certain temperature to start the curing reaction. This will also initiate the curing of the adhesives between the joints of the two metal parts and strengthen the joints.

As a result, one obtains a composite structure with an inner glass fiber reinforced layer that covers fully the inner surface of the metal shell. During the subsequent third step the opening for the outlet or valve is made and other finalizing work is done to render the cylinder functional.

A schematic of the steps for internally coating the cylinder is shown in FIG. 3. In FIG. 3a, the two pieces of the cylinder 20, 21 are joined, with adhesives. The top portion 21 already has a threaded opening 22. In FIG. 3b, the rotation is begun to create the centrifugal force after the fiberglass/resin mixture 23 has been introduced into the cylinder. In FIG. 3c, the inside of the cylinder has been coated 24, and the resin binder is cured in order to set the internal coating comprising the fiberglass reinforcement. In FIG. 3d, a valve 25 is added to complete the cylinder.

The glass fibers used as reinforcement should be at least 0.25 inch long or longer, more preferably at least one half inch or three quarters inch long and most preferably at least about one inch long, but mixtures of fibers of different lengths and/or fiber diameters can be used as is known. These fibers can be coated with a silane containing size composition as is well known in the industry. A preferred continuous glass fiber for use include at least one member selected from the group consisting of E, C, and T type and sodium borosilicate glasses, and mixtures thereof. As is known in the glass art, C glass typically has a soda-lime-borosilicate composition that provides it with enhanced chemical stability in corrosive environments, and T glass usually has a magnesium aluminosilicate composition and especially high tensile strength in filament form. The E glass is also known as electrical glass and typically has a calcium aluminoborosilicate composition and a maximum alkali content of 2.0%. E glass fiber is commonly used to reinforce various articles and is therefore preferred. The chopped fibers of the major portion can have varying lengths, but more commonly are substantially of similar length. E glass fiber has sufficiently high strength and other mechanical properties to produce excellent reinforcement and is relatively low in cost and widely available. Most preferred is E glass having an average fiber diameter of about 11.+−.1.5 μm and a length ranging from about 6 to 12 mm.

Any known water resistant resinous binder can be used with the glass fiber. Suitable binders include urea formaldehyde; conventional modified urea formaldehyde; acrylic resins; melamine resins, preferably having a high nitrogen resins such as those disclosed by U.S. Pat. No. 5,840,413; homopolymers or copolymers of polyacrylic acid having a molecular weight of less than 10,000, preferably less than 3,000; crosslinking acrylic copolymer having a glass transition temperature (GTT) of at least about 25° C., crosslinked vinyl chloride acrylate copolymers having a GTT preferably no higher than about 113° C.; and other known flame and water resistant conventional resins. An acrylic resin is preferred, as it is easily cured and performs well with glass fiber.

The resulting gas container will exhibit high strength, low weight, versatile use, good aesthetics, and high production speed.

Having thus described the invention in detail, it will be understood that such detail need not be strictly adhered to, but that additional changes and modifications may suggest themselves to one skilled in the art, all falling within the scope of the invention as defined by the subjoined claims.

What is claimed is:

1. A metallic cylinder, comprised of an outer metallic body and an inner layer of glass fiber reinforced resin.

2. The cylinder of claim 1, wherein the cylinder is a high pressure gas cylinder.

3. The cylinder of claim 1, wherein the resin comprises an acrylic polymer.

4. The cylinder of claim 1, wherein the glass fibers used as reinforcement are composed of glass fibers at least 0.25 inch in length.

5. The cylinder of claim 1, wherein the glass fibers used as reinforcement re comprised of glass fibers of at least 1.0 inch in length.

6. The cylinder of claim 1, wherein the glass fiber is comprised of an E, C or T type glass.

7. The cylinder of claim 6, wherein the glass fiber is comprised of an E glass.

8. A method for preparing the metallic cylinder of claim 1, which comprises
a) providing a metallic cylinder,
b) introducing a glass fiber/resin mixture into the cylinder, and
c) rotating the cylinder to create an inner layer of glass fiber reinforced resin in the metallic cylinder.

9. The method of claim 8, wherein the cylinder is heated during rotation in order to cure the resin of the glass fiber/resin mixture.

10. The method of claim 8, wherein the glass fiber is comprised of glass fibers at least 0.25 inch in length.

11. The method of claim 8, wherein the glass fiber is comprised of glass fibers at least 1.0 inch in length.

12. The method of claim 8, wherein the glass fiber is comprised of E glass fibers.
